(19) United States
(12) Patent Application Publication
(10) Pub. No.: US 2018/0357404 A1
(43) Pub. Date: Dec. 13, 2018

(54) INFORMATION PROCESSING METHOD AND APPARATUS, AND ELECTRONIC DEVICE

(71) Applicant: Beijing Kingsoft Internet Security Software Co., Ltd., Beijing (CN)

(72) Inventors: Zhongyi PENG, Beijing (CN); Wenyuan JI, Beijing (CN)

(21) Appl. No.: 15/779,187

(22) PCT Filed: Nov. 23, 2016
(86) PCT No.: PCT/CN2016/106858

§ 371 Date: May 25, 2018

(30) Foreign Application Priority Data
Nov. 27, 2015 (CN) 201510850122.4

(51) Int. Cl. G06F 21/36; G06F 21/32; G06F 17/24

(52) U.S. Cl. CPC G06F 21/36; G06F 17/243; G06F 21/32

(57) ABSTRACT

A method is disclosed comprising: monitoring whether a display interface of an application in a foreground running state contains a user identity authentication area; if yes, determining whether user identity authentication is to be performed in a quick authentication manner; obtaining a quick authentication password input by the user, when it is determined that the user identity authentication is to be performed in the quick authentication manner; determining whether the password is a quick authentication password of any piece of user identity information corresponding to the display interface stored in the preset information list; if yes, obtaining, from user identity information corresponding to the display interface stored in the preset information list, user identity information corresponding to the quick authentication password; when a system privilege is obtained, sending the obtained information to the application to perform the user identity authentication via a server according to the information.

### CROSS-REFERENCE TO RELATED APPLICATIONS

This application is a national phase under 35 U.S.C. § 371 of International Application No. PCT/CN2016/106858, filed Nov. 23, 2016, which The present disclosure claims priority to Chinese patent application No. 201510850122.4 filed with the State Intellectual Property Office of the People's Republic of China on Nov. 27, 2015 entitled “INFORMATION PROCESSING METHOD AND APPARATUS, AND ELECTRONIC DEVICE”, each of which are incorporated herein by reference in their entirety.

### TECHNICAL FIELD

The present disclosure relates to the technical field of computer software, and particularly to a method and apparatus for processing information, and an electronic device.

### BACKGROUND

In recent years, with the rapid development of hardware technology, the performance of a terminal used by a user is becoming more and more powerful, and applications that can be run thereon are increasing. Usually, a user needs to first register an account number of an application or website, and then can access the application or website according to the registered account number.

Specifically, when the user accesses an application or website, he/she needs to input information such as an account number and password in a user identity information authentication area in the application or webpage, then the application or browser sends a request for authenticating user identity to a server according to the input information such as an account number and password, and the server performs user identity authentication after receiving the request.

Although the user identity authentication can be achieved successfully in the above method, since applications or websites have different registration requirements in practical application, information such as account numbers and passwords registered by the user may vary. In this case, the user needs to remember multiple different account numbers, passwords and other information. As the number of applications used by the user or the number of websites accessed by the user increases, the number of account numbers and passwords to be remembered by the user increases. As such, the user will bear the greater pressure. In addition, whenever accessing a webpage of a website or an application, the user needs to input information such as an account number and password. In this case, the operation is complex, and thus it is not easy to access webpage information of a website or an application, such that the poor user experience is generated.

### SUMMARY

Embodiments of the present disclosure provide a method and apparatus for processing information, and an electronic device, so as to simplify an operation process, facilitate the access to webpage information of websites, and thus improve the user experience.

To achieve the above objective, embodiments of the present disclosure disclose a method for processing information, the method comprising:
monitoring whether a display interface of an application in a foreground running state contains a user identity authentication area;
if the display interface of the application in the foreground running state contains a user identity authentication area, determining whether user identity authentication is to be performed in a quick authentication manner;
obtaining a quick authentication password input by a user, if the user identity authentication is to be performed in the quick authentication manner;
determining whether the quick authentication password input by the user is a quick authentication password of any piece of user identity information corresponding to the display interface stored in a preset information list, wherein the preset information list is used to store user identity information corresponding to an interface containing a user identity authentication area and quick authentication passwords corresponding to respective pieces of user identity information;
if the quick authentication password input by the user is the quick authentication password of any piece of user identity information corresponding to the display interface, obtaining, from user identity information corresponding to the display interface stored in the preset information list, user identity information corresponding to the quick authentication password input by the user; and
when a system privilege is obtained, sending the obtained user identity information to the application in the foreground running state, so as to the application in the foreground running state to perform the user identity authentication via a server according to the obtained user identity information.

In a specific implementation of the present disclosure, determining whether user identity authentication is to be performed in a quick authentication manner comprises:
determining whether the preset information list contains user identity information corresponding to the display interface, and if the preset information list does not contain the user identity information corresponding to the display interface, determining that the user identity authentication is not to be performed in the quick authentication manner.

In a specific implementation of the present disclosure, determining whether user identity authentication is to be performed in a quick authentication manner comprises:
determining whether the preset information list contains user identity information corresponding to the display interface;
if the preset information list contains user identity information corresponding to the display interface, displaying selection information for the quick authentication manner; and
determining whether the user identity authentication is to be performed in the quick authentication manner, according to the user's selection operation for the selection information.

In a specific implementation of the present disclosure, obtaining, from user identity information corresponding to the display interface stored in the preset information list, user identity information corresponding to the quick authentication password input by the user comprises:
determining the user identity information corresponding to the display interface stored in the preset information list;
obtaining, from the determined user identity information, the number of pieces of user identity information whose quick authentication password is consistent with the quick authentication password input by the user;
determining whether the obtained number is larger than 1; and
if the obtained number is larger than 1, obtaining the user identity information corresponding to the quick authentication password input by the user, according to the user's selection operation for the determined user identity information.

In a specific implementation of the present disclosure, when it is determined that the user identity authentication is not to be performed in the quick authentication manner, the method further comprises:
when the system privilege is obtained, obtaining user identity information Inf_{UID} input by the user in the user identity authentication area of the display interface;
when it is determined that the user identity authentication is successful and a preset information determination condition is satisfied, determining whether a correspondence between the display interface and the user identity information Inf_{UID} is to be stored in the preset information list;
if the correspondence is to be stored in the preset information list, storing the correspondence between the display interface and the user identity information Inf_{UID} in the preset information list according to a preset information storage rule.

In a specific implementation of the present disclosure, storing the correspondence between the display interface and the user identity information Inf_{UID} in the preset information list according to a preset information storage rule comprises:
determining whether the preset information list contains a quick authentication password;
if the preset information list contains a quick authentication password, storing the correspondence between the display interface and the user identity information Inf_{UID} in the preset information list;
if the preset information list does not contain the quick authentication password, obtaining the quick authentication password input by the user, determining the obtained quick authentication password as a quick authentication password corresponding to the user identity information Inf_{UID}, and storing the correspondence between the display interface and the user identity information Inf_{UID} and the quick authentication password corresponding to the user identity information Inf_{UID} in the preset information list.

In a specific implementation of the present disclosure, before storing the correspondence between the display interface and the user identity information Inf_{UID} in the preset information list, the method further comprises:
obtaining an identity authentication password input by the user;
determining whether the identity authentication password is consistent with the quick authentication password in the preset information list;
if the identity authentication password is consistent with the quick authentication password in the preset information list, storing the correspondence between the display interface and the user identity information Inf_{UID} in the preset information list.

In a specific implementation of the present disclosure, storing the correspondence between the display interface and the user identity information Inf_{UID} in the preset information list according to a preset information storage rule comprises:
obtaining a category to which the display interface belongs;
determining whether the preset information list contains a category quick authentication password corresponding to the category;
if the preset information list contains a category quick authentication password corresponding to the category, determining the category quick authentication password as a quick authentication password corresponding to the user identity information Inf_{UID}; and
if the preset information list does not contain the category quick authentication password corresponding to the category, obtaining a category quick authentication password input by the user, determining the obtained category quick authentication password as the quick authentication password corresponding to the user identity information Inf_{UID}, and storing the correspondence between the display interface and the user identity information Inf_{UID} and the quick authentication password corresponding to the user identity information Inf_{UID} in the preset information list.

In a specific implementation of the present disclosure, determining whether the preset information list contains a category quick authentication password corresponding to the category comprises:
obtaining an identity authentication password input by the user;
determining whether the identity authentication password is consistent with a category quick authentication password stored in the preset information list according to the category;
if the identity authentication password is consistent with a category quick authentication password stored in the preset information list, determining that the preset information list contains the category quick authentication password corresponding to the category.

In a specific implementation of the present disclosure, storing the correspondence between the display interface and the user identity information Inf_{UID} in the preset information list according to a preset information storage rule comprises:
obtaining the quick authentication password input by the user;
determining the quick authentication password input by the user as a quick authentication password corresponding to the user identity information Inf_{UID}; and
storing the correspondence between the display interface and the user identity information Inf_{UID} and the quick authentication password corresponding to the user identity information Inf_{UID} in the preset information list.

In a specific implementation of the present disclosure, when the system privilege is obtained, obtaining user identity information Inf_{UID} input by the user in the user identity authentication area of the display interface comprises:
when the system privilege is obtained, obtaining each piece of character information input by the user in the user identity authentication area of the display interface by calling a preset function, and obtaining the user identity information Inf_{UID} according to the obtained character information; or
when the system privilege is obtained, obtaining the user identity information Inf_{UID} according to a preset character recognition algorithm, after confirming that the user has finished inputting the user identity information Inf_{UID} in the user identity authentication area of the display interface.

In a specific implementation of the present disclosure, when it is determined that the user identity authentication is successful and a preset information determination condition is satisfied, determining whether a correspondence between the display interface and the user identity information Inf_{UID} is to be stored in the preset information list, comprises:
when it is determined that the user identity authentication is successful, monitoring whether the application in the foreground running state displays prompt information stored for user information;
if the application in the foreground running state displays the prompt information stored for user information, closing the prompt information, and setting the application in the foreground running state to refuse to display the prompt information again; and determining whether the correspondence between the display interface and the user identity information Inf_{UID} is to stored in the preset information list.

In a specific implementation of the present disclosure, when the system privilege is obtained, sending the obtained user identity information to the application in the foreground running state, comprises:
when the system privilege is obtained, filling the obtained user identity information in the user identity authentication area of the application in the foreground running state in virtual clicking and virtual inputting manners.

In a specific implementation of the present disclosure, the method for processing information further comprises:
detecting whether the system privilege is obtained;
if the system privilege is not obtained, displaying prompt information for opening the system privilege.

To achieve the above objective, embodiments of the present disclosure disclose an apparatus for processing information, the apparatus comprising:
an interface determining module configured to monitor whether a display interface of an application in a foreground running state contains a user identity authentication area;
an authentication manner determining module configured to determine whether user identity authentication is to be performed in a quick authentication manner when the interface determining module determines that the display interface contains a user identity authentication area;
an authentication password obtaining module configured to obtain a quick authentication password input by a user when the authentication manner determining module determines that the user identity authentication is to be performed in the quick authentication manner;
an authentication password determining module configured to determine whether the quick authentication password input by the user is a quick authentication password of any piece of user identity information corresponding to the display interface stored in a preset information list, wherein the preset information list is used to store user identity information corresponding to an interface containing a user identity authentication area and quick authentication passwords corresponding to respective pieces of user identity information;
a first user identity information obtaining module configured to, when the authentication password determining module determines that the quick authentication password input by the user is the quick authentication password of any piece of user identity information corresponding to the display interface stored in the preset information list, obtain, from user identity information corresponding to the display interface stored in the preset information list, user identity information corresponding to the quick authentication password input by the user;
a user identity information sending module configured to, when a system privilege is obtained, send the obtained user identity information to the application in the foreground running state, so as to the application in the foreground running state to perform the user identity authentication via a server according to the obtained user identity information.

In a specific implementation of the present disclosure, the authentication manner determining module is configured to determine whether the preset information list contains user identity information corresponding to the display interface, and if the preset information list does not contain the user identity information corresponding to the display interface, determine that the user identity authentication is not to be performed in the quick authentication manner.

In a specific implementation of the present disclosure, the authentication manner determining module comprises:
a user identity information determining sub-module configured to determine whether the preset information list contains user identity information corresponding to the display interface;
a selection information displaying sub-module configured to display selection information for the quick authentication manner, when the user identity information determining sub-module determines that the preset information list contains user identity information corresponding to the display interface;
an authentication manner determining sub-module configured to determine whether the user identity authentication is to be performed in the quick authentication manner, according to the user's selection operation for the selection information.

In a specific implementation of the present disclosure, the first user identity information obtaining module comprises:
a user identity information determining sub-module configured to determine the user identity information corresponding to the display interface stored in the preset information list;
an information number obtaining sub-module configured to obtain, from the determined user identity information, the number of pieces of user identity information whose quick authentication password is consistent with the quick authentication password input by the user;
an information number determining sub-module configured to determine whether the obtained number is larger than 1;
a user identity information obtaining sub-module configured to, when the information number determining sub-module determines that the obtained number is larger than 1, obtain the user identity information corresponding to the quick authentication password input by the user, according to the user's selection operation for the determined user identity information.

In a specific implementation of the present disclosure, the apparatus for processing information further comprises:
a second user identity information obtaining module configured to, when it is determined that the user identity authentication is not to be performed in the quick authentication manner and the system privilege is obtained, obtain user identity information Inf_{UID} input by the user in the user identity authentication area of the display interface;
a correspondence storage determining module configured to, when it is determined that the user identity authentication is successful and a preset information determination condition is satisfied, determine whether a correspondence between the display interface and the user identity information Inf_{UID} is to be stored in the preset information list;
a correspondence storage module configured to, when the correspondence storage determining module determines that the correspondence between the display interface and the user identity information Inf_{UID} is to be stored in the preset information list, store the correspondence between the display interface and the user identity information Inf_{UID} in the preset information list according to a preset information storage rule.

In a specific implementation of the present disclosure, the correspondence storage module comprises:
a first authentication password determining sub-module configured to determine whether the preset information list contains a quick authentication password;
a first correspondence storage sub-module configured to, when the first authentication password determining sub-module determines that the preset information list contains a quick authentication password, store the correspondence between the display interface and the user identity information Inf_{UID} in the preset information list;
a second correspondence storage sub-module configured to, when the first authentication password determining sub-module determines that the preset information list does not contain the quick authentication password, obtain the quick authentication password input by the user, determine the obtained quick authentication password as the quick authentication password corresponding to the user identity information Inf_{UID}, and store the correspondence between the display interface and the user identity information Inf_{UID} and the quick authentication password corresponding to the user identity information Inf_{UID} in the preset information list.

In a specific implementation of the present disclosure, the correspondence storage module further comprises:
an authentication password obtaining sub-module configured to obtain an identity authentication password input by the user, before the first correspondence storage sub-module stores the correspondence;
an authentication password determining sub-module configured to determine whether the identity authentication password is consistent with the quick authentication password in the preset information list, and if the identity authentication password is consistent with the quick authentication password in the preset information list, trigger the first correspondence storage sub-module to store the correspondence.

In a specific implementation of the present disclosure, the correspondence storage module comprises:
a category obtaining sub-module configured to obtain a category to which the display interface belongs;
a second authentication password determining sub-module configured to determine whether the preset information list contains a category quick authentication password corresponding to the category;
a third correspondence storage sub-module configured to, when the second authentication password determining sub-module determines that the preset information list contains a category quick authentication password corresponding to the category, determine the category quick authentication password as the quick authentication password corresponding to the user identity information Inf_{UID};
a fourth correspondence storage sub-module configured to, when the second authentication password determining sub-module determines that the preset information list does not contain the category quick authentication password corresponding to the category, obtain a category quick authentication password input by the user, determine the obtained category quick authentication password as the quick authentication password corresponding to the user identity information Inf_{UID}, and store the correspondence between the display interface and the user identity information Inf_{UID} and the quick authentication password corresponding to the user identity information Inf_{UID} in the preset information list.

In a specific implementation of the present disclosure, the second authentication password determining sub-module comprises:
an authentication password obtaining unit configured to obtain an identity authentication password input by the user;
an authentication password determining unit configured to determine whether the identity authentication password is consistent with a category quick authentication password stored in the preset information list according to the category, and if the identity authentication password is consistent with a category quick authentication password stored in the preset information list, determine that the preset information list contains the category quick authentication password corresponding to the category.

In a specific implementation of the present disclosure, the correspondence storage module comprises:
an authentication password obtaining sub-module configured to obtain the quick authentication password input by the user;
an authentication password determining sub-module configured to determine the quick authentication password input by the user as a quick authentication password corresponding to the user identity information Inf_{UID};
a fifth correspondence storage sub-module configured to store the correspondence between the display interface and the user identity information Inf_{UID} and the quick authentication password corresponding to the user identity information Inf_{UID} in the preset information list.

In a specific implementation of the present disclosure, the second user identity information obtaining module is specifically configured to,
when the system privilege is obtained, obtain each piece of character information input by the user in the user identity authentication area of the display interface by calling a preset function, and obtain the user identity information Inf_{UID} according to the obtained character information; or
when the system privilege is obtained, obtain the user identity information Inf_{UID} according to a preset character recognition algorithm, after confirming that the user has finished inputting the user identity information Inf_{UID} in the user identity authentication area of the display interface.

In a specific implementation of the present disclosure, the correspondence storage determining module comprises:
a prompt information monitoring sub-module configured to, when it is determined that the user identity authentication is successful, monitor whether the application in the foreground running state displays prompt information stored for user information;
a prompt information setting sub-module configured to, when the prompt information monitoring sub-module monitors that the application in the foreground running state displays the prompt information stored for the user information, close the prompt information, and set the application in the foreground running state to refuse to display the prompt information again;
a correspondence storage determining sub-module configured to determine whether the correspondence between the display interface and the user identity information Inf_{UID} is to be stored in the preset information list.

In a specific implementation of the present disclosure, the user identity information sending module is configured to, when the system privilege is obtained, fill the obtained user identity information in the user identity authentication area of the application in the foreground running state in virtual clicking and virtual inputting manners.

In a specific implementation of the present disclosure, the apparatus for processing information further comprises:
a system privilege detecting module configured to detect whether the system privilege is obtained;
a prompt information displaying module configured to display prompt information for opening the system privilege when the system privilege detecting module detects that the system privilege is obtained.

To achieve the above objective, embodiments of the present disclosure further provide an electronic device, comprising: a housing, a processor, a memory, a circuit board and a power supply circuit, wherein the circuit board is disposed in a space surrounded by the housing, and the processor and the memory are disposed on the circuit board; the power supply circuit is configured to supply power for circuits and elements of the electronic device; the memory is configured to store executable program codes; the processor is configured to execute a program corresponding to the executable program codes by reading the executable program codes stored in the memory, so as to cause the processor to:
monitor whether a display interface of an application in a foreground running state contains a user identity authentication area;
if the display interface of the application in the foreground running state contains a user identity authentication area, determine whether user identity authentication is to be performed in a quick authentication manner;
obtain a quick authentication password input by a user, if the user identity authentication is to be performed in the quick authentication manner;
determine whether the quick authentication password input by the user is a quick authentication password of any piece of user identity information corresponding to the display interface stored in a preset information list, wherein the preset information list is used to store user identity information corresponding to an interface containing a user identity authentication area and quick authentication passwords corresponding to respective pieces of user identity information;
if the quick authentication password input by the user is the quick authentication password of any piece of user identity information corresponding to the display interface, obtain, from user identity information corresponding to the display interface stored in the preset information list, user identity information corresponding to the quick authentication password input by the user; and
when a system privilege is obtained, send the obtained user identity information to the application in the foreground running state, so as to the application in the foreground running state to perform the user identity authentication via a server according to the obtained user identity information.

To achieve the above objective, embodiments of the present disclosure further provide an application which, when be executing, performs the method for processing information in the above implementations.

To achieve the above objective, embodiments of the present disclosure further provide a storage medium for storing executable program codes, wherein the executable program codes are used to perform the method for processing information in above implementations.

As can be seen from the above, in the solutions provided in embodiments of the present disclosure, in the case that it is monitored that the display interface of the application in the foreground running state contains a user identity authentication area and it is determined that user identity authentication is to be performed in a quick authentication manner, a quick authentication password input by the user is obtained; when it is determined that the quick authentication password is a quick authentication password of any piece of user identity information corresponding to the display interface stored in the preset information list, the user identity information corresponding to the quick authentication password input by the user is obtained from the user identity information corresponding to the display interface stored in the preset information list; when a system privilege is obtained, the obtained user identity information is then sent to the application which is currently in the foreground running state, so as to the application which is currently in the foreground running state to perform the user identity authentication via a server according to the obtained user identity information. As compared with the prior art, in the present disclosure, after various user identity information is stored in the preset information list, the user identity authentication can be performed as long as the user memorizes and inputs the quick authentication password, thereby simplifying the operation process, facilitating the access to webpage information of applications and websites, and improving the user experience.

### BRIEF DESCRIPTION OF THE DRAWINGS

In order to more clearly describe the embodiments of the present application and the technical solutions in the prior art, drawings that need to be used in embodiments and the prior art will be briefly described below. Obviously, the drawings provided below are for only some embodiments of the present application; those skilled in the art can also obtain other drawings based on these drawings without any creative efforts.

FIG. 1 is a flow chart of a first method for processing information according to an embodiment of the present disclosure;

FIG. 2a is a schematic diagram of a first interface according to an embodiment of the present disclosure;

FIG. 2b is a schematic diagram of a second interface according to an embodiment of the present disclosure;

FIG. 3 is a flow chart of a second method for processing information according to an embodiment of the present disclosure;

FIG. 4a is a schematic diagram of a third interface according to an embodiment of the present disclosure;

FIG. 4b is a schematic diagram of a fourth interface according to an embodiment of the present disclosure;

FIG. 5 is a structural schematic diagram of a first apparatus for processing information according to an embodiment of the present disclosure;

FIG. 6 is a structural schematic diagram of a second apparatus for processing information according to an embodiment of the present disclosure;

FIG. 7 is a structural schematic diagram of an electronic device according to an embodiment of the present disclosure.

### DETAILED DESCRIPTION

In order to make the objectives, technical solutions, and advantages of the present application clearer and more understandable, the present application will be described in more detail below with reference to the appended drawings and embodiments. Obviously, the described embodiments are only some, and not all, of the embodiments of the present application. All other embodiments obtained based on the embodiments of the present application by those skilled in the art without any creative efforts fall into the scope of protection defined by the present application.

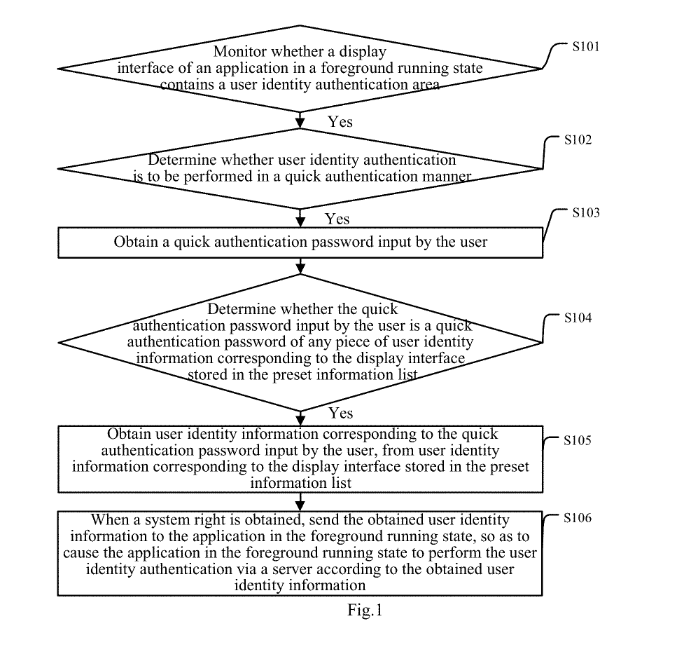

FIG. 1 is a flow chart of a first method for processing information according to an embodiment of the present disclosure. The method comprises S101-S106.

S101: monitoring whether a display interface of an application in a foreground running state contains a user identity authentication area, and, if yes, executing S102.

The application in the foreground running state may be a browser, an application having a function of a browser, and other various applications. This is not limited in the present disclosure.

The user identity authentication area generally refers to an area where the user inputs user identity information such as an account number, a password and the like. The user identity authentication area may include: an account number input box, a password input box, a registration button, a login button and the like. This is not limited in the present disclosure.

Specifically, in practical application, whether the display interface contains a user identity authentication area may be determined in many ways.

Generally, whether the display interface contains a user identity authentication area may be determined by determining whether source codes of the display interface include keywords such as “account number”, “password”, “register”, “login” and the like.

In another case, whether the display interface contains a user identity authentication area may be determined by recognizing whether the display interface includes keywords such as “account number”, “password” and the like, or an information input box with a preset size, or other information, through a preset recognition algorithm.

In a further case, whether the display interface contains a user identity authentication area may be determined by determining whether an identifier of the display interface is in a preset interface list, wherein the preset interface list is used to store identifiers of interfaces containing a user identity authentication area.

In a further case, whether the display interface contains a user identity authentication area may be determined by determining whether web address information of the display interface includes a preset keyword such as “login” and the like.

It should be noted that the above ways are only examples of the present disclosure. In practical application, the way of determining whether the display interface contains a user identity authentication area is not limited to these.

S102: determining whether user identity authentication is to be performed in a quick authentication manner, and if yes, executing S103.

Specifically, in a specific implementation of the present disclosure, whether to perform user identity authentication in a quick authentication manner may be determined by determining whether a preset information list contains user identity information corresponding to the display interface. Specifically, if the preset information list does not contain the user identity information corresponding to the display interface, it may be determined that the user identity authentication is not to be performed in a quick authentication manner.

The preset information list is used to store user identity information corresponding to an interface containing a user identity authentication area and quick authentication passwords corresponding to respective pieces of user identity information.

In another specific implementation of the present disclosure, determining whether user identity authentication is to be performed in a quick authentication manner may include: first determining whether the preset information list contains user identity information corresponding to the display interface; if the preset information list contains a user identity information corresponding to the display interface, displaying selection information for the quick authentication manner; and determining whether the user identity authentication is to be performed in the quick authentication manner, according to the user's selection operation for the selection information.

It may be appreciated that the user's selection operation generally may be divided into two categories: one category represents that the user agrees to perform user identity authentication in a quick authentication manner, and the other category represents that the user does not agree to perform user identity authentication in a quick authentication manner.

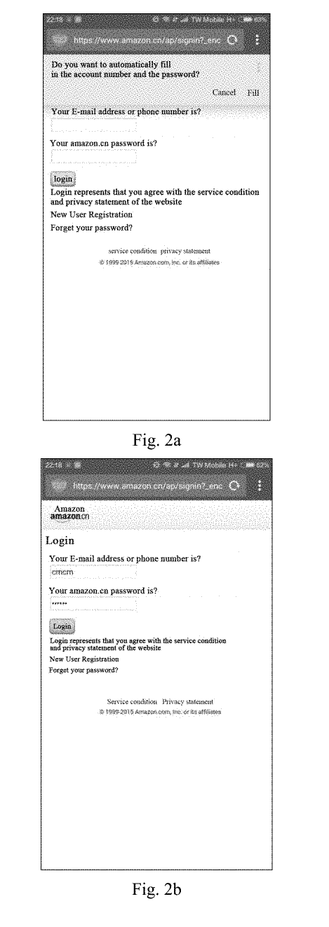

Specifically, reference is made to FIG. 2a, which provides a schematic diagram of a first interface. In the schematic diagram, the selection information for the quick authentication manner is displayed by means of prompt information “Do you want to automatically fill the account number and the password?”

S103: obtaining a quick authentication password input by a user.

Specifically, the quick authentication password may be a digital password, a gesture password, a graphic password, a fingerprint password, an image password, a speech password and so on. This is not limited in the present disclosure.

S104: determining whether the quick authentication password input by the user is a quick authentication password of any piece of user identity information corresponding to the display interface stored in a preset information list, and if yes, executing S105.

The preset information list is used to store user identity information corresponding to an interface containing a user identity authentication area and quick authentication passwords corresponding to respective pieces of user identity information.

It should be noted that quick authentication passwords corresponding to all user identity information stored in the preset information list may be the same quick authentication password, or different quick authentication passwords.

Furthermore, the user identity information of interfaces in the same category may correspond to the same quick authentication password.

The user identity information of interfaces in multiple preset categories may correspond to the same quick authentication password.

One piece of user identity information corresponds to one quick authentication password.

The user identity information of the same interface corresponds to different quick authentication passwords.

The above illustration is only examples of the present disclosure. In practical application, the correspondence of the user identity information and the quick authentication password is not limited to this.

In addition, in the case that the preset information list stores quick authentication passwords corresponding to respective pieces of user identity information, it is possible that each piece of user identity information corresponds to one quick authentication password stored, or that the whole list only stores one quick authentication password, or that the whole list only stores a quick authentication password corresponding to each category, or the like.

S105: obtaining user identity information corresponding to the quick authentication password input by the user, from user identity information corresponding to the display interface stored in the preset information list.

Specifically, the user identity information corresponding to the display interface stored in the preset information list may contain only one piece of user identity information whose quick authentication password is the same as the quick authentication password input by the user, or may contain multiple pieces of user identity information with quick authentication passwords being the same as the quick authentication password input by the user.

In the case that there is only one piece of user identity information whose quick authentication password is the same as the quick authentication password input by the user, the user identity information whose quick authentication password is the same as the quick authentication password input by the user may serve as the user identity information corresponding to the quick authentication password input by the user.

In the case that there are multiple pieces of user identity information with quick authentication passwords being the same as the quick authentication password input by the user, obtaining the user identity information corresponding to the quick authentication password input by the user may includes: first determining user identity information corresponding to the display interface stored in the preset information list, then obtaining, from the determined user identity information, the number of pieces of user identity information whose quick authentication password is consistent with the quick authentication password input by the user, determining whether the obtained number is larger than 1, and if yes, obtain the user identity information corresponding to the quick authentication password input by the user, according to the user's selection operation for the determined user identity information.

S106: when a system privilege is obtained, sending the obtained user identity information to the application in the foreground running state, so as to the application in the foreground running state to perform the user identity authentication via a server according to the obtained user identity information.

As appreciated by those skilled in the art, it is necessary to communicate with the application to successfully send the obtained user identity information to the application which is currently in the foreground running state. Specifically, after the system privilege is obtained, it is possible to communicate with the application.

Specifically, when the obtained user information is to be sent to the application which is currently in the foreground running state, the obtained user information may be sent directly to the application, and the obtained user information is not displayed in the user identity authentication area. In this case, the application which is currently in the foreground running state may directly generate a request for authenticating user identity according to the obtained user information, and send the request for authenticating user identity to the server, and the server performs the user identity authentication according to the received request for authenticating user identity.

In addition, when the obtained user information is sent to the application which is currently in the foreground running state, the obtained user information may also be displayed in the user identity authentication area. Specifically, when the system privilege is obtained, it is possible to fill the obtained user identity information in the user identity authentication area of the application which is currently in the foreground running state, in virtual clicking and virtual inputting manners, then send a login instruction to the application which is currently in the foreground running state in a virtual click manner. In this way, the application may generate a request for authenticating user identity according to content in the user identity authentication area, and send the request for authenticating user identity to the server, and the server performs the user identity authentication according to the received request for authenticating user identity.

Specifically, reference is made to FIG. 2b, which provides a schematic diagram of a second interface. The schematic diagram shows an interface in which the user identity information is already filled in the user identity authentication area.

Specifically, auxiliary functions of the system generally can implement functions such as virtual clicking, virtual inputting and the like. Hence, in an optional implementation of the present disclosure, the above system privilege may be understood as the right to auxiliary functions of the system.

In an optional implementation of the present disclosure, the method for processing information may further comprise:
detecting whether the system privilege is obtained;
if the system privilege is not obtained, displaying prompt information for opening the system privilege.

As can be seen from the above, in the solution provided by the present embodiment, in the case that it is monitored that the display interface of the application in the foreground running state contains a user identity authentication area and it is determined that user identity authentication is to be performed in a quick authentication manner, a quick authentication password input by the user is obtained; when it is determined that the quick authentication password is a quick authentication password of any piece of user identity information corresponding to the display interface stored in the preset information list, the user identity information corresponding to the quick authentication password input by the user is obtained from the user identity information corresponding to the display interface stored in the preset information list; when a system privilege is obtained, the obtained user identity information is then sent to the application which is currently in the foreground running state, so as to the application which is currently in the foreground running state to perform the user identity authentication via a server according to the obtained user identity information. As compared with the prior art, in the present disclosure, after various user identity information is stored in the preset information list, the user identity authentication can be performed as long as the user memorizes and inputs the quick authentication password, thereby simplifying the operation process, facilitating the access to webpage information of applications and websites, and improving the user experience.

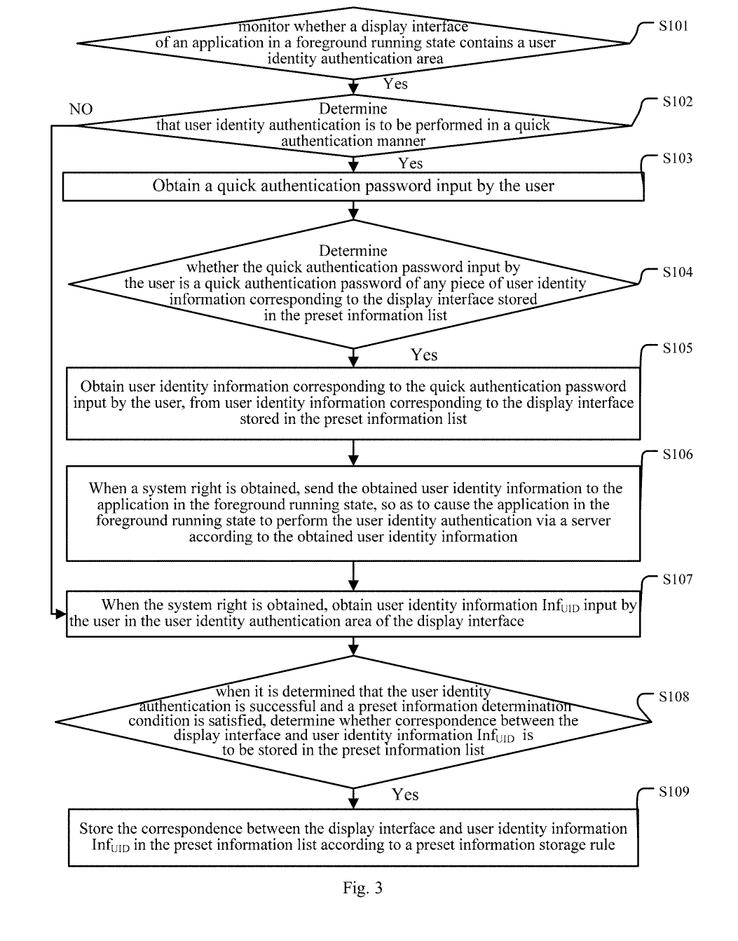

In a specific implementation of the present disclosure, reference is made to FIG. 3, which provides a flow chart of a second method for processing information. As compared with the preceding embodiment, in the present embodiment, in the case that it is determined in S102 to not perform the user identity authentication in the quick authentication manner, the method further comprises S107-S109.

S107: when the system privilege is obtained, obtaining user identity information Inf_{UID} input by the user in the user identity authentication area of the display interface.

Specifically, obtaining the user identity information Inf_{UID} input by the user in the user identity authentication area of the display interface may include: when the system privilege is obtained, obtaining each piece of character information input by the user in the user identity authentication area of the display interface by calling a preset function, and obtaining the user identity information Inf_{UID} according to the obtained character information; or when the system privilege is obtained, obtaining user identity information Inf_{UID} according to a preset character recognition algorithm, after confirming that the user has finished inputting the user identity information Inf_{UID} in the user identity authentication area of the display interface. This is not limited in the present disclosure.

Obtaining user identity information Inf_{UID} according to the preset character recognition algorithm may be understood as: using the preset character recognition algorithm to perform character recognition on the user identity authentication area to obtain a character recognition result, and then obtaining the user identity information Inf_{UID} according to the character recognition result. For example, all characters included in the character recognition result may be taken as the user identity information Inf_{UID}; or characters whose confidence is higher than a preset threshold in the character recognition result may be taken as the user identity information Inf_{UID}. Certainly, the user identity information Inf_{UID} may also be obtained in other manners.

S108: when it is determined that the user identity authentication is successful and a preset information determination condition is satisfied, determining whether a correspondence between the display interface and the user identity information Inf_{UID} is to be stored in the preset information list, and if yes, executing S109.

Specifically, the client may display prompt information for information storage to the user; the user performs selection based on the prompt information; then the client determines whether the correspondence between the display interface and user identity information Inf_{UID} is to be stored in the preset information list, according to the user's selection operation.

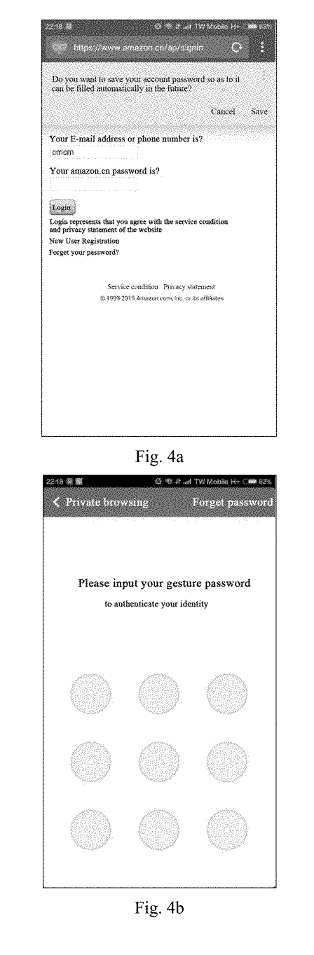

Specifically, reference is made to FIG. 4a, which provides a schematic diagram of a third interface. In the schematic diagram, the user is prompted with information such as “Do you want to save your account password so as to it can be filled automatically in the future?”

In practical application, the application which is currently in the foreground running state may further store user information input by the user. In view of this, in an optional implementation of the present disclosure, determining whether a correspondence between the display interface and the user identity information Inf_{UID} is to be stored in the preset information list, when it is determined that the user identity authentication is successful and a preset information determination condition is satisfied, may include: when it is determined that the user identity authentication is successful, monitoring whether the application which is currently in the foreground running state displays prompt information for the user information storage; if yes, closing the prompt information, and setting the application which is currently in the foreground running state to refuse to display the prompt information again; determining whether the correspondence between the display interface and the user identity information Inf_{UID} is to be stored in the preset information list.

In addition, the preset information determination condition may be a determination condition that it is necessary to determine whether the correspondence between the display interface and the user identity information Inf_{UID} is to be stored in the preset information list, in any situation. This is not limited in the present disclosure.

S109: storing the correspondence between the display interface and the user identity information Inf_{UID} in the preset information list, according to a preset information storage rule.

In an optional implementation of the present disclosure, storing the correspondence between the display interface and user identity information Inf_{UID} in the preset information list according to a preset information storage rule may include: first determining whether the preset information list contains a quick authentication password; if yes, storing the correspondence between the display interface and user identity information Inf_{UID} in the preset information list; if not, obtaining the quick authentication password input by the user, determining the obtained quick authentication password as the quick authentication password corresponding to the user identity information Inf_{UID}, and storing the correspondence between the display interface and user identity information Inf_{UID} and the quick authentication password corresponding to the user identity information Inf_{UID} in the preset information list.

In an optional implementation, it may be understood that the quick authentication password stored in the preset information list is the quick authentication password for each piece of user identity information in the list.

Specifically, before storing the correspondence between the display interface and user identity information Inf_{UID} in the preset information list, it is further possible to obtain the identity authentication password input by the user, and determine whether the identity authentication password is consistent with the quick authentication password in the preset information list. If yes, step S110 is executed.

The identity authentication password is input by the user, and like the quick authentication password, there are many possible identity authentication passwords, which will not be listed here. Specifically, reference is made to FIG. 4b, which provides a schematic diagram of a fourth interface. In the schematic diagram, the displayed interface is an interface on which the user inputs a gesture password.

In another optional implementation of the present disclosure, storing the correspondence between the display interface and user identity information Inf_{UID} in the preset information list according to a preset information storage rule may include: first obtaining a category to which the display interface belongs, then determining whether the preset information list contains a category quick authentication password corresponding to the category; if yes, determining the category quick authentication password as the quick authentication password corresponding to the user identity information Inf_{UID}; if not, obtaining the category quick authentication password input by the user, determining the obtained category quick authentication password as the quick authentication password corresponding to the user identity information Inf_{UID}, and storing the correspondence between the display interface and user identity information Inf_{UID} and the quick authentication password corresponding to the user identity information Inf_{UID} in the preset information list.

In practical application, there are many factors for dividing interfaces into different categories.

For example, the interfaces may be divided into different categories according to websites corresponding to the interfaces, for example, dividing the interfaces corresponding to Sina to one category, dividing the interfaces corresponding to Baidu to one category, and so on.

For example, the interfaces may be divided into different categories according to content displayed on the interfaces, for example, dividing the interfaces that display shopping information to one category (e.g., shopping category), dividing the interfaces that display mail information to one category (e.g., mail category), and so on.

It should be noted that the above examples are only used for illustration in the present disclosure. In practical application, factors for dividing interfaces into different categories are not limited to these.

Specifically, determining whether the preset information list contains a category quick authentication password corresponding to the category may include: first obtaining the identity authentication password input by the user, then determining whether the identity authentication password is consistent with a category quick authentication password stored in the preset information list according to the category, and if yes, determining that the preset information list contains the category quick authentication password corresponding to the category.

In another optional implementation of the present disclosure, storing the correspondence between the display interface and user identity information Inf_{UID} in the preset information list according to a preset information storage rule may include: obtaining the quick authentication password input by the user, determining the quick authentication password input by the user as the quick authentication password corresponding to the user identity information Inf_{UID}, and storing the correspondence between the display interface and user identity information Inf_{UID} and the quick authentication password corresponding to the user identity information Inf_{UID} in the preset information list.

It should be noted that in the optional implementation, the quick authentication password input by the user may be the same as or different from the quick authentication password of the user identity information stored in the preset information list. This is not limited in the present disclosure.

As can be seen from the above, in the solution provided in the present embodiment, when it is determined to not perform user identity authentication in the quick authentication manner, when it is determined that the user identity authentication is successful, it is determined whether the correspondence between the display interface and user identity information Inf_{UID} is to be stored in the preset information list, and the correspondence between the display interface and the user identity information Inf_{UID} is stored in the preset information list according to a preset information storage rule. As such, when the user wants to access the display interface again, he/she may quickly access the display interface according to information stored in the preset information list.

Corresponding to the above method for processing information, embodiments of the present disclosure further provide an apparatus for processing information.

FIG. 5 is a structural schematic diagram of a first apparatus for processing information according to an embodiment of the present disclosure. The apparatus comprises:
an interface determining module 501 configured to monitor whether a display interface of an application in a foreground running state contains a user identity authentication area;
an authentication manner determining module 502 configured to determine whether user identity authentication is to be performed in a quick authentication manner when the interface determining module 501 determines that the display interface contains a user identity authentication area;
an authentication password obtaining module 503 configured to obtain a quick authentication password input by a user when the authentication manner determining module 502 determines that the user identity authentication is to be performed in the quick authentication manner;
an authentication password determining module 504 configured to determine whether the quick authentication password input by the user is a quick authentication password of any piece of user identity information corresponding to the display interface stored in the preset information list, wherein the preset information list is used to store user identity information corresponding to an interface containing a user identity authentication area and quick authentication passwords corresponding to respective pieces of user identity information;
a first user identity information obtaining module 505 configured to, when the authentication password determining module 504 determines that the quick authentication password input by the user is the quick authentication password of any piece of user identity information corresponding to the display interface stored in the preset information list, obtain user identity information corresponding to the quick authentication password input by the user from user identity information corresponding to the display interface stored in the preset information list;
a user identity information sending module 506 configured to, when a system privilege is obtained, send the obtained user identity information to the application in the foreground running state, so as to the application in the foreground running state to perform the user identity authentication via a server according to the obtained user identity information.

Specifically, the authentication manner determining module 502 may be configured to determine whether the preset information list contains user identity information corresponding to the display interface, and if not, determine that the user identity authentication is not to be performed in the quick authentication manner.

Specifically, the authentication manner determining module 502 may include:
a user identity information determining sub-module configured to determine whether the preset information list contains user identity information corresponding to the display interface;
a selection information displaying sub-module configured to display selection information for the quick authentication manner, when the user identity information determining sub-module determines that the preset information list contains user identity information corresponding to the display interface;
an authentication manner determining sub-module configured to determine whether the user identity authentication is to be performed in the quick authentication manner, according to the user's selection operation for the selection information.

Specifically, the first user identity information obtaining module 505 may include:
a user identity information determining sub-module configured to determine the user identity information corresponding to the display interface stored in the preset information list;
an information number obtaining sub-module configured to obtain, from the determined user identity information, the number of pieces of user identity information whose quick authentication password is consistent with the quick authentication password input by the user;
an information number determining sub-module configured to determine whether the obtained number is larger than 1;
a user identity information obtaining sub-module configured to, when the information number determining sub-module determines that the obtained number is larger than 1, obtain the user identity information corresponding to the quick authentication password input by the user, according to the user's selection operation for the determined user identity information.

In an optional implementation of the present disclosure, the user identity information sending module 506 may be specifically configured to, when the system privilege is obtained, fill the obtained user identity information in the user identity authentication area of the application in the foreground running state in virtual clicking and virtual inputting manners.

Specifically, the apparatus for processing information may further comprise:
a system privilege detecting module configured to detect whether the system privilege is obtained;
a prompt information displaying module configured to display prompt information for opening the system privilege when the system privilege detecting module detects that the system privilege is obtained.

As can be seen from the above, in the solution provided by the present embodiment, in the case that it is monitored that the display interface of the application in the foreground running state contains a user identity authentication area and it is determined that the user identity authentication is to be performed in a quick authentication manner, a quick authentication password input by the user is obtained; when it is determined that the quick authentication password is a quick authentication password of any piece of user identity information corresponding to the display interface stored in the preset information list, the user identity information corresponding to the quick authentication password input by the user is obtained from the user identity information corresponding to the display interface stored in the preset information list; when a system privilege is obtained, the obtained user identity information is then sent to the application which is currently in the foreground running state, so as to the application which is currently in the foreground running state to perform the user identity authentication via a server according to the obtained user identity information. As compared with the prior art, in the present disclosure, after various user identity information is stored in the preset information list, the user identity authentication can be performed as long as the user memorizes and inputs the quick authentication password, thereby simplifying the operation process, facilitating the access to webpage information of websites, and improving the user experience.

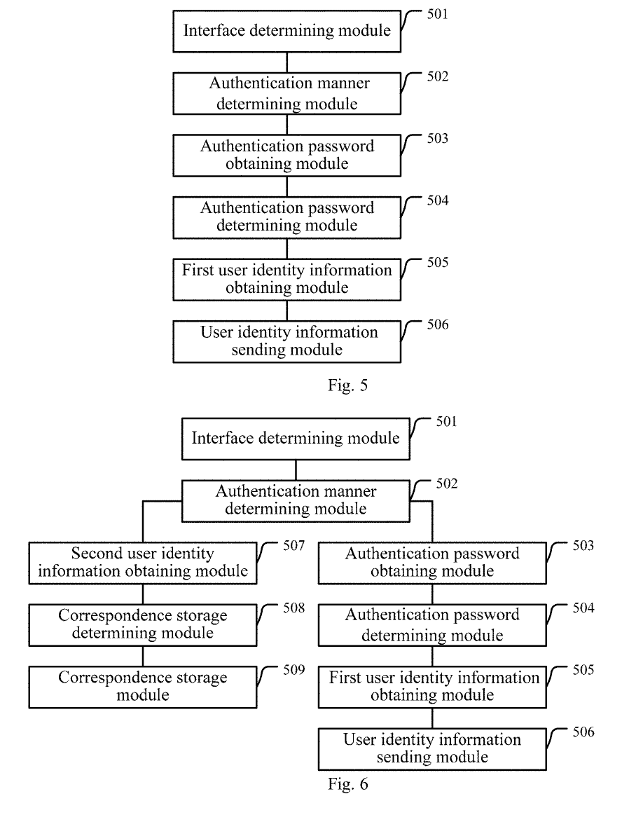

In a specific implementation of the present disclosure, reference is made to FIG. 6, which provides a flow chart of a second information processing method. As compared with the preceding embodiment, in the present embodiment, the apparatus for processing information further comprises:
a second user identity information obtaining module 507 configured to, when it is determined that the user identity authentication is not to be performed in the quick authentication manner and obtaining the system privilege, obtain user identity information Inf_{UID} input by the user in the user identity authentication area of the display interface;
a correspondence storage determining module 508 configured to, when it is determined that the user identity authentication is successful and a preset information determination condition is satisfied, determine whether the correspondence between the display interface and the user identity information Inf_{UID} is to be stored in the preset information list;
a correspondence storage module 509 configured to, when the correspondence storage determining module 508 determines that the correspondence between the display interface and the user identity information Inf_{UID} is to be stored in the preset information list, store the correspondence between the display interface and the user identity information Inf_{UID} in the preset information list according to a preset information storage rule.

In an optional implementation of the present disclosure, the correspondence storage module 508 may include:
a first authentication password determining sub-module configured to determine whether the preset information list contains a quick authentication password;
a first correspondence storage sub-module configured to, when the first authentication password determining sub-module determines that the preset information list contains a quick authentication password, store the correspondence between the display interface and the user identity information Inf_{UID} in the preset information list;
a second correspondence storage sub-module configured to, when the first authentication password determining sub-module determines that the preset information list does not contain the quick authentication password, obtain the quick authentication password input by the user, determine the obtained quick authentication password as the quick authentication password corresponding to the user identity information Inf_{UID}, and store the correspondence between the display interface and the user identity information Inf_{UID} and the quick authentication password corresponding to the user identity information Inf_{UID} in the preset information list.

Specifically, the correspondence storage module 509 may further comprise:
an authentication password obtaining sub-module configured to obtain the identity authentication password input by the user, before the first correspondence storage sub-module stores the correspondence;
an authentication password determining sub-module configured to determine whether the identity authentication password is consistent with the quick authentication password in the preset information list, and if the identity authentication password is consistent with the quick authentication password in the preset information list, trigger the first correspondence storage sub-module to store the correspondence.

In another optional implementation of the present disclosure, the correspondence storage module 508 may comprise:
a category obtaining sub-module configured to obtain a category to which the display interface belongs;
a second authentication password determining sub-module configured to determine whether the preset information list contains a category quick authentication password corresponding to the category;
a third correspondence storage sub-module configured to, when the second authentication password determining sub-module determines that the preset information list contains a category quick authentication password corresponding to the category, determine the category quick authentication password as the quick authentication password corresponding to the user identity information Inf_{UID};
a fourth correspondence storage sub-module configured to, when the second authentication password determining sub-module determines that the preset information list does not contain the category quick authentication password corresponding to the category, obtain a category quick authentication password input by the user, determine the obtained category quick authentication password as the quick authentication password corresponding to the user identity information Inf_{UID}, and store the correspondence between the display interface and the user identity information Inf_{UID} and the quick authentication password corresponding to the user identity information Inf_{UID} in the preset information list.

Specifically, the second authentication password determining sub-module may comprise:
an authentication password obtaining unit configured to obtain the identity authentication password input by the user;
an authentication password determining unit configured to, according to the category, determine whether the identity authentication password is consistent with a category quick authentication password stored in the preset information list, and if the identity authentication password is consistent with a category quick authentication password stored in the preset information list, determine that the preset information list contains the category quick authentication password corresponding to the category.

In another optional implementation of the present disclosure, the correspondence storage module 508 may comprise:
an authentication password obtaining sub-module configured to obtain the quick authentication password input by the user;
an authentication password determining sub-module configured to determine the quick authentication password input by the user as the quick authentication password corresponding to the user identity information Inf_{UID};
a fifth correspondence storage sub-module configured to store the correspondence between the display interface and the user identity information Inf_{UID} and the quick authentication password corresponding to the user identity information Inf_{UID} in the preset information list.

Specifically, the second user identity information obtaining module 507 is configured to,

When the system privilege is obtained, obtain each piece of character information input by the user in the user identity authentication area of the display interface by calling a preset function, and obtain the user identity information Inf_{UID} according to the obtained character information; or

When the system privilege is obtained, obtain the user identity information Inf_{UID} according to a preset character recognition algorithm, after confirming that the user has finished inputting the user identity information Inf_{UID} in the user identity authentication area of the display interface.

Specifically, the correspondence storage determining module 508 may include:
a prompt information monitoring sub-module configured to, when it is determined that the user identity authentication is successful, monitor whether the application in the foreground running state displays prompt information stored for the user information;
a prompt information setting sub-module configured to, when the prompt information monitoring sub-module monitors that the application in the foreground running state displays prompt information stored for the user information, close the prompt information, and set the application in the foreground running state to refuse to display the prompt information again;
a correspondence storage determining sub-module configured to determine whether a correspondence between the display interface and the user identity information Inf_{UID} is to be stored in the preset information list.

As can be seen from the above, in the solution provided in the present embodiment, when it is determined to not perform user identity authentication in the quick authentication manner, when it is determined that the user identity authentication is successful, it is determined whether the correspondence between the display interface and the user identity information Inf_{UID} is to be stored in the preset information list, and the correspondence between the display interface and the user identity information Inf_{UID} is stored in the preset information list according to a preset information storage rule. As such, when the user wants to access the display interface again, he/she may quickly access the display interface according to information stored in the preset information list.

Corresponding to the above method for processing information and the apparatus for processing information, embodiments of the present disclosure further provide an electronic device.

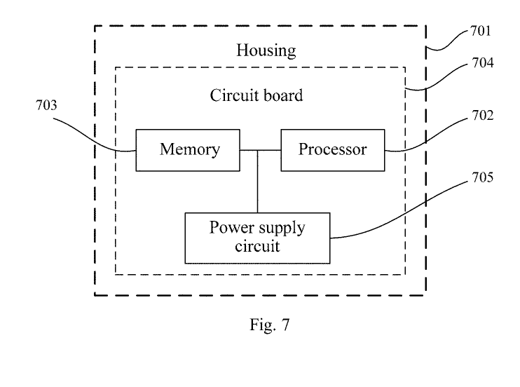

FIG. 7 is a structural schematic diagram of an electronic device according to an embodiment of the present disclosure. The electronic device comprises: a housing 701, a processor 702, a memory 703, a circuit board 704 and a power supply circuit 705, wherein the circuit board 704 is disposed in a space surrounded by the housing 701, and the processor 702 and the memory 703 are disposed on the circuit board 704; the power supply circuit 705 is configured to supply power circuits and elements of the electronic device; the memory 703 is configured to store executable program codes; the processor 702 is configured to execute a program corresponding to the executable program codes by reading the executable program codes stored in the memory 703, so as to cause the processor to:
monitor whether a display interface of an application in a foreground running state contains a user identity authentication area;
if the display interface of the application in a foreground running state contains a user identity authentication area, determine whether user identity authentication is to be performed in a quick authentication manner;
obtain a quick authentication password input by the user, if the user identity authentication is to be performed in the quick authentication manner;
determine whether the quick authentication password input by the user is a quick authentication password of any piece of user identity information corresponding to the display interface stored in the preset information list, wherein the preset information list is used to store user identity information corresponding to an interface containing a user identity authentication area and quick authentication passwords corresponding to respective pieces of user identity information;
if the quick authentication password input by the user is the quick authentication password of any piece of user identity information corresponding to the display interface, obtain user identity information corresponding to the quick authentication password input by the user, from user identity information corresponding to the display interface stored in the preset information list;
when a system privilege is obtained, send the obtained user identity information to the application in the foreground running state, so as to the application in the foreground running state to perform the user identity authentication via a server according to the obtained user identity information.

Reference may be made to depictions of embodiments shown in FIGS. 1-6 of the present disclosure, for a specific execution process of the above steps by the processor 702 and steps further executed by the processor 702 by running the executable program codes. Detailed depictions thereof are not presented here.

The electronic device can exist in many forms, including but not limited to:

(1) mobile communication device: this type of device is characterized by having mobile communication functions, with a primary purposes to provide voice and data communication. Such terminals include: smart phones (e.g., iPhone), multimedia phones, functional phones, low-end phones and the like.

(2) ultra-mobile personal computer device: this type of device belongs to the category of personal computers, has computing and processing functions, and generally also has mobile network properties. Such terminals include: PDA, MID, UMPC (e.g., iPad) and the like.

(3) portable entertainment device: this type of device can display and play multimedia contents. Such devices include: audio and video players (e.g., iPod), handheld game players, ebooks, and smart toys and portable onboard navigation devices.

(4) server: it is a device that provides computing service. The compositions of the server include a processor, a hard disk, a memory, and a system bus. The architecture of the server is similar to that of a general computer. The server has relatively high requirements in terms of processing capacity, stability, reliability, security, expandability, manageability and the like due to the provision of highly reliable service.

(5) other electronic devices that have a data interaction function.

As can be seen from the above, in the solution provided in the present embodiment, when it is monitored that the display interface of the application in the foreground running state contains a user identity authentication area and it is determined that the user identity authentication is to be performed in a quick authentication manner, the electronic device obtains a quick authentication password input by the user; when it is determined that the quick authentication password is a quick authentication password of any piece of user identity information corresponding to the display interface stored in the preset information list, the electronic device obtains the user identity information corresponding to the quick authentication password input by the user from the user identity information corresponding to the display interface stored in the preset information list; when a system privilege is obtained, the electronic device then sends the obtained user identity information to the application which is currently in the foreground running state, so as to cause the application which is currently in the foreground running state to perform the user identity authentication via a server according to the obtained user identity information. As compared with the prior art, in the present disclosure, after various user identity information is stored in the preset information list, the user identity authentication can be performed as long as the user memorizes and inputs the quick authentication password, thereby simplifying the operation process, facilitating the access to webpage information of websites, and improving the user experience.

Embodiments of the present disclosure further provide an application which, when being executed, performs the method for processing information according to the above embodiments, wherein, the method for processing information comprises:
monitoring whether a display interface of an application in a foreground running state contains a user identity authentication area;
if the display interface of the application in a foreground running state contains a user identity authentication area, determining whether user identity authentication is to be performed in a quick authentication manner;
obtaining a quick authentication password input by a user, if the user identity authentication is to be performed in the quick authentication manner;
determining whether the quick authentication password input by the user is a quick authentication password of any piece of user identity information corresponding to the display interface stored in the preset information list, wherein the preset information list is used to store user identity information corresponding to an interface containing a user identity authentication area and quick authentication passwords corresponding to respective pieces of user identity information;
if the quick authentication password input by the user is the quick authentication password of any piece of user identity information corresponding to the display interface, obtaining user identity information corresponding to the quick authentication password input by the user, from user identity information corresponding to the display interface stored in the preset information list;
when a system privilege is obtained, sending the obtained user identity information to the application in the foreground running state, so as to cause the application which in the foreground running state to perform the user identity authentication via a server according to the obtained user identity information.

As can be seen from the above, in the solution provided in the present embodiment, when the application is executed, in the case that it is monitored that a display interface of an application in the foreground running state contains a user identity authentication area and it is determined that user identity authentication is to be performed in a quick authentication manner, a quick authentication password input by the user is obtained; when it is determined that the quick authentication password is a quick authentication password of any piece of user identity information corresponding to the display interface stored in the preset information list, the user identity information corresponding to the quick authentication password input by the user is obtained from the user identity information corresponding to the display interface stored in the preset information list; when a system privilege is obtained, the obtained user identity information is then sent to the application which is currently in the foreground running state, so as to cause the application which is currently in the foreground running state to perform the user identity authentication via a server according to the obtained user identity information. As compared with the prior art, in the present disclosure, after various user identity information is stored in the preset information list, the user identity authentication can be performed as long as the user memorizes and inputs the quick authentication password, thereby simplifying the operation process, facilitating the access to webpage information of websites, and improving the user experience.

Embodiments of the present disclosure further provide a storage medium for storing executable codes, the executable codes being used for the method for processing information according to the above embodiments, wherein, the method for processing information comprises:
monitoring whether a display interface of an application in a foreground running state contains a user identity authentication area;
if the display interface of the application in a foreground running state contains a user identity authentication area, determining whether user identity authentication is to be performed in a quick authentication manner;
obtaining a quick authentication password input by a user, if the user identity authentication is to be performed in the quick authentication manner;
determining whether the quick authentication password input by the user is a quick authentication password of any piece of user identity information corresponding to the display interface stored in the preset information list, wherein the preset information list is used to store user identity information corresponding to an interface containing a user identity authentication area and quick authentication passwords corresponding to respective pieces of user identity information;
if the quick authentication password input by the user is the quick authentication password of any piece of user identity information corresponding to the display interface, obtaining user identity information corresponding to the quick authentication password input by the user, from user identity information corresponding to the display interface stored in the preset information list;
when a system privilege is obtained, sending the obtained user identity information to the application in the foreground running state, so as to cause the application which in the foreground running state to perform the user identity authentication via a server according to the obtained user identity information.

As can be seen from the above, in the solution provided in the present embodiment, when the executable codes stored in the storage medium is executed, in the case that it is monitored that a display interface of an application in the foreground running state contains a user identity authentication area and it is determined that user identity authentication is to be performed in a quick authentication manner, a quick authentication password input by the user is obtained; when it is determined that the quick authentication password is a quick authentication password of any piece of user identity information corresponding to the display interface stored in the preset information list, the user identity information corresponding to the quick authentication password input by the user is obtained from the user identity information corresponding to the display interface stored in the preset information list; when a system privilege is obtained, the obtained user identity information is then sent to the application which is currently in the foreground running state, so as to the application which is currently in the foreground running state to perform the user identity authentication via a server according to the obtained user identity information. As compared with the prior art, in the present disclosure, after various user identity information is stored in the preset information list, the user identity authentication can be performed as long as the user memorizes and inputs the quick authentication password, thereby simplifying the operation process, facilitating the access to webpage information of websites, and improving the user experience.

The embodiments of the apparatus, electronic device, application and storage medium are described briefly, because these embodiments are substantially similar to the method embodiments previously described. Relevant parts can be well understood with reference to explanations in the method embodiments.

It should be noted that in the claims and the specification, relationship terms such as “first,” “second” and the like are only used to distinguish one entity or operation from another entity or operation, and do not necessarily require or imply that there is any such actual relationship or order between those entities or operations. Moreover, the terms “include,” “comprise” or any other variants are intended to cover a non-exclusive inclusion, such that processes, methods, objects or devices including a series of elements include not only those elements, but also other elements not specified or the elements inherent to those processes, methods, objects or devices. Without further limitations, elements limited by the phrase “comprise(s) a . . . ” and “include(s) a . . . ” do not exclude that there are other identical elements in the processes, methods, objects or devices that include those elements.

Those skilled in the art may understand that all or a part of steps in the method embodiments may be implemented by a program instructing a relevant hardware. The program may stored in a computer readable storage medium, such as a Read-Only Memory (ROM)/Random Access Memory (RAM), a magnetic disk, an optical disk and so on.

Embodiments described above are just preferred embodiments of the present application, and not intended to limit the scope of the present invention. Any modifications, equivalent, improvement or the like within the spirit and principle of the present invention should be included in the scope of the present invention.

1. A method for processing information, comprising:
monitoring whether a display interface of an application in a foreground running state contains a user identity authentication area;
if the display interface of the application in the foreground running state contains a user identity authentication area, determining whether user identity authentication is to be performed in a quick authentication manner;
obtaining a quick authentication password input by a user, if the user identity authentication is to be performed in the quick authentication manner;
determining whether the quick authentication password input by the user is a quick authentication password of any piece of user identity information corresponding to the display interface stored in a preset information list, wherein the preset information list is used to store user identity information corresponding to an interface containing a user identity authentication area and quick authentication passwords corresponding to respective pieces of user identity information;
if the quick authentication password input by the user is the quick authentication password of any piece of user identity information corresponding to the display interface, obtaining, from user identity information corresponding to the display interface stored in the preset information list, user identity information corresponding to the quick authentication password input by the user; and
when a system privilege is obtained, sending the obtained user identity information to the application in the foreground running state, so as to cause the application in the foreground running state to perform the user identity authentication via a server according to the obtained user identity information.

2. The method according to claim 1, wherein determining whether user identity authentication is to be performed in a quick authentication manner comprises:
determining whether the preset information list contains user identity information corresponding to the display interface, and if the preset information list does not contain the user identity information corresponding to the display interface, determining that the user identity authentication is not to be performed in the quick authentication manner,
or wherein,
determining whether user identity authentication is to be performed in a quick authentication manner comprises:
determining whether the preset information list contains user identity information corresponding to the display interface;
if the preset information list contains user identity information corresponding to the display interface, displaying selection information for the quick authentication manner; and
determining whether the user identity authentication is to be performed in the quick authentication manner, according to the user's selection operation for the selection information.

3. (canceled)

4. The method according to claim 1, wherein obtaining, from user identity information corresponding to the display interface stored in the preset information list, user identity information corresponding to the quick authentication password input by the user comprises:
determining the user identity information corresponding to the display interface stored in the preset information list;
obtaining, from the determined user identity information, the number of pieces of user identity information whose quick authentication password is consistent with the quick authentication password input by the user;
determining whether the obtained number is larger than 1; and
if the obtained number is larger than 1, obtaining the user identity information corresponding to the quick authentication password input by the user, according to the user's selection operation for the determined user identity information;
or wherein,
when the system privilege is obtained, sending the obtained user identity information to the application in the foreground running state, comprises:
when the system privilege is obtained, filling the obtained user identity information in the user identity authentication area of the application in the foreground running state in virtual clicking and virtual inputting manners;
or wherein,
the method further comprises:
detecting whether the system privilege is obtained; and
if the system privilege is not obtained, displaying prompt information for opening the system privilege.

5. The method according to claim 1, wherein when it is determined that the user identity authentication is not to be performed in the quick authentication manner, the method further comprises:
when the system privilege is obtained, obtaining user identity information Inf_{UID} input by the user in the user identity authentication area of the display interface;
when it is determined that the user identity authentication is successful and a preset information determination condition is satisfied, determining whether a correspondence between the display interface and the user identity information Inf_{UID} is to be stored in the preset information list;
if the correspondence is to be stored in the preset information list, storing the correspondence between the display interface and the user identity information Inf_{UID} in the preset information list according to a preset information storage rule.

6. The method according to claim 5, wherein storing the correspondence between the display interface and the user identity information Inf_{UID} in the preset information list according to a preset information storage rule comprises:
determining whether the preset information list contains a quick authentication password;
if the preset information list contains a quick authentication password, storing the correspondence between the display interface and the user identity information Inf_{UID} in the preset information list;
if the preset information list does not contain a quick authentication password, obtaining the quick authentication password input by the user, determining the obtained quick authentication password as a quick authentication password corresponding to the user identity information Inf_{UID}, and storing the correspondence between the display interface and the user identity information Inf_{UID} and the quick authentication password corresponding to the user identity information Inf_{UID} in the preset information list;
or wherein,
storing the correspondence between the display interface and the user identity information Inf_{UID} in the preset information list according to a preset information storage rule comprises:
obtaining a category to which the display interface belongs;
determining whether the preset information list contains a category quick authentication password corresponding to the category;
if the preset information list contains a category quick authentication password corresponding to the category, determining the category quick authentication password as a quick authentication password corresponding to the user identity information Inf_{UID}; and
if the preset information list does not contain a category quick authentication password corresponding to the category, obtaining a category quick authentication password input by the user, determining the obtained category quick authentication password as the quick authentication password corresponding to the user identity information Inf_{UID}, and storing the correspondence between the display interface and the user identity information Inf_{UID} and the quick authentication password corresponding to the user identity information Inf_{UID} in the preset information list;
or wherein,
storing the correspondence between the display interface and the user identity information Inf_{UID} in the preset information list according to a preset information storage rule comprises:
obtaining the quick authentication password input by the user;
determining the quick authentication password input by the user as a quick authentication password corresponding to the user identity information Inf_{UID}; and
storing the correspondence between the display interface and the user identity information Inf_{UID} and the quick authentication password corresponding to the user identity information Inf_{UID} in the preset information list.

7. The method according to claim 6, wherein before storing the correspondence between the display interface and the user identity information Inf_{UID} in the preset information list, the method further comprises:
obtaining an identity authentication password input by the user;
determining whether the identity authentication password is consistent with the quick authentication password in the preset information list;
if the identity authentication password is consistent with the quick authentication password in the preset information list, storing the correspondence between the display interface and the user identity information Inf_{UID} in the preset information list.

8. (canceled)

9. The method according to claim 6, wherein determining whether the preset information list contains a category quick authentication password corresponding to the category comprises:
obtaining an identity authentication password input by the user;
determining whether the identity authentication password is consistent with a category quick authentication password stored in the preset information list according to the category;
if the identity authentication password is consistent with a category quick authentication password stored in the preset information list, determining that the preset information list contains the category quick authentication password corresponding to the category.

10. (canceled)

11. The method according to claim 5, wherein when the system privilege is obtained, obtaining user identity information Inf_{UID} input by the user in the user identity authentication area of the display interface comprises:
when the system privilege is obtained, obtaining each piece of character information input by the user in the user identity authentication area of the display interface by calling a preset function, and obtaining the user identity information Inf_{UID} according to the obtained character information; or
when the system privilege is obtained, obtaining the user identity information Inf_{UID} according to a preset character recognition algorithm after confirming that the user has finished inputting the user identity information Inf_{UID} in the user identity authentication area of the display interface.

12. The method according to claim 5, wherein when it is determined that the user identity authentication is successful and a preset information determination condition is satisfied, determining whether a correspondence between the display interface and the user identity information Inf_{UID} is to be stored in the preset information list, comprises:
when it is determined that the user identity authentication is successful, monitoring whether the application in the foreground running state displays prompt information stored for user information;
if the application in the foreground running state displays the prompt information stored for user information, closing the prompt information, and setting the application in the foreground running state to refuse to display the prompt information again; and
determining whether the correspondence between the display interface and the user identity information Inf_{UID} is to be stored in the preset information list.

13-14. (canceled)

15. An apparatus for processing information, comprising:
an interface determining module configured to monitor whether a display interface of an application in a foreground running state contains a user identity authentication area;
an authentication manner determining module configured to determine whether user identity authentication is to be performed in a quick authentication manner when the interface determining module determines that the display interface contains a user identity authentication area;
an authentication password obtaining module configured to obtain a quick authentication password input by a user when the authentication manner determining module determines that the user identity authentication is to be performed in the quick authentication manner;
an authentication password determining module configured to determine whether the quick authentication password input by the user is a quick authentication password of any piece of user identity information corresponding to the display interface stored in a preset information list, wherein the preset information list is used to store user identity information corresponding to an interface containing a user identity authentication area and quick authentication passwords corresponding to respective pieces of user identity information;
a first user identity information obtaining module configured to, when the authentication password determining module determines that the quick authentication password input by the user is the quick authentication password of any piece of user identity information corresponding to the display interface stored in the preset information list, obtain, from user identity information corresponding to the display interface stored in the preset information list, user identity information corresponding to the quick authentication password input by the user;
a user identity information sending module configured to, when a system privilege is obtained, send the obtained user identity information to the application in the foreground running state, so as to cause the application in the foreground running state to perform the user identity authentication via a server according to the obtained user identity information.

16. The apparatus according to claim 15, wherein the authentication manner determining module is configured to determine whether the preset information list contains user identity information corresponding to the display interface, and if the preset information list does not contain the user identity information corresponding to the display interface, determine that the user identity authentication is not to be performed in the quick authentication manner;
or wherein,
the authentication manner determining module comprises:
a user identity information determining sub-module configured to determine whether the preset information list contains user identity information corresponding to the display interface;
a selection information displaying sub-module configured to display selection information for the quick authentication manner, when the user identity information determining sub-module determines that the preset information list contains user identity information corresponding to the display interface;
an authentication manner determining sub-module configured to determine whether the user identity authentication is to be performed in the quick authentication manner, according to the user's selection operation for the selection information.

17. (canceled)

18. The apparatus according to claim 15, wherein the first user identity information obtaining module comprises:
a user identity information determining sub-module configured to determine the user identity information corresponding to the display interface stored in the preset information list;
an information number obtaining sub-module configured to obtain, from the determined user identity information, the number of pieces of user identity information whose quick authentication password is consistent with the quick authentication password input by the user;
an information number determining sub-module configured to determine whether the obtained number is larger than 1;
a user identity information obtaining sub-module configured to, when the information number determining sub-module determines that the obtained number is larger than 1, obtain the user identity information corresponding to the quick authentication password input by the user, according to the user's selection operation for the determined user identity information;
or wherein,
the user identity information sending module is configured to, when obtaining the system privilege, fill the obtained user identity information in the user identity authentication area of the application in the foreground running state in virtual clicking and virtual inputting manners;
or wherein,
the apparatus further comprising:
a system privilege detecting module configured to detect whether the system privilege is obtained;
a prompt information displaying module configured to display prompt information for opening the system privilege when the system privilege detecting module detects that the system privilege is obtained.

19. The apparatus according to claim 15, further comprising:
a second user identity information obtaining module configured to, when it is determined that the user identity authentication is not to be performed in the quick authentication manner and the system privilege is obtained, obtain user identity information Inf_{UID} input by the user in the user identity authentication area of the display interface;
a correspondence storage determining module configured to, when it is determined that the user identity authentication is successful and a preset information determination condition is satisfied, determine whether a correspondence between the display interface and the user identity information Inf_{UID} is to be stored in the preset information list;
a correspondence storage module configured to, when the correspondence storage determining module determines that the correspondence between the display interface and the user identity information Inf_{UID} is to be stored in the preset information list, store the correspondence between the display interface and the user identity information Inf_{UID} in the preset information list according to a preset information storage rule.

20. The apparatus according to claim 19, wherein the correspondence storage module comprises:
a first authentication password determining sub-module configured to determine whether the preset information list contains a quick authentication password;
a first correspondence storage sub-module configured to, when the first authentication password determining sub-module determines that the preset information list contains a quick authentication password, store the correspondence between the display interface and the user identity information Inf_{UID} in the preset information list;
a second correspondence storage sub-module configured to, when the first authentication password determining sub-module determines that the preset information list does not contain the quick authentication password, obtain the quick authentication password input by the user, determine the obtained quick authentication password as the quick authentication password corresponding to the user identity information Inf_{UID}, and store the correspondence between the display interface and the user identity information Inf_{UID} and the quick authentication password corresponding to the user identity information Inf_{UID} in the preset information list;
or wherein,
the correspondence storage module comprises:
a category obtaining sub-module configured to obtain a category to which the display interface belongs;
a second authentication password determining sub-module configured to determine whether the preset information list contains a category quick authentication password corresponding to the category;
a third correspondence storage sub-module configured to, when the second authentication password determining sub-module determines that the preset information list contains a category quick authentication password corresponding to the category, determine the category quick authentication password as the quick authentication password corresponding to the user identity information Inf_{UID};
a fourth correspondence storage sub-module configured to, when the second authentication password determining sub-module determines that the preset information list does not contain the category quick authentication password corresponding to the category, obtain a category quick authentication password input by the user, determine the obtained category quick authentication password as the quick authentication password corresponding to the user identity information Inf_{UID}, and store the correspondence between the display interface and the user identity information Inf_{UID} and the quick authentication password corresponding to the user identity information Inf_{UID} in the preset information list;
or wherein,
the correspondence storage module comprises:
an authentication password obtaining sub-module configured to obtain the quick authentication password input by the user;
an authentication password determining sub-module configured to determine the quick authentication password input by the user as a quick authentication password corresponding to the user identity information Inf_{UID};
a fifth correspondence storage sub-module configured to store the correspondence between the display interface and the user identity information Inf_{UID} and the quick authentication password corresponding to the user identity information Inf_{UID} in the preset information list.

21. The apparatus according to claim 20, wherein the correspondence storage module further comprises:
an authentication password obtaining sub-module configured to obtain an identity authentication password input by the user, before the first correspondence storage sub-module stores the correspondence;
an authentication password determining sub-module configured to determine whether the identity authentication password is consistent with the quick authentication password in the preset information list, and if the identity authentication password is consistent with the quick authentication password in the preset information list, trigger the first correspondence storage sub-module to store the correspondence.

22. (canceled)

23. The apparatus according to claim 20, wherein the second authentication password determining sub-module comprises:
an authentication password obtaining unit configured to obtain an identity authentication password input by the user;
an authentication password determining unit configured to determine whether the identity authentication password is consistent with a category quick authentication password stored in the preset information list according to the category, and if the identity authentication password is consistent with a category quick authentication password stored in the preset information list, determine that the preset information list contains the category quick authentication password corresponding to the category.

24. (canceled)

25. The apparatus according to claim 19, wherein the second user identity information obtaining module is configured to,
when the system privilege is obtained, obtain each piece of character information input by the user in the user identity authentication area of the display interface by calling a preset function, and obtain the user identity information Inf_{UID} according to the obtained character information; or
when the system privilege is obtained, obtain the user identity information Inf_{UID} according to a preset character recognition algorithm, after confirming that the user has finished inputting the user identity information Inf_{UID} in the user identity authentication area of the display interface.

26. The apparatus according to claim 19, wherein the correspondence storage determining module comprises:
a prompt information monitoring sub-module configured to, when it is determined that the user identity authentication is successful, monitor whether the application in the foreground running state displays prompt information stored for user information;
a prompt information setting sub-module configured to, when the prompt information monitoring sub-module monitors that the application in the foreground running state displays the prompt information stored for the user information, close the prompt information, and set the application in the foreground running state to refuse to display the prompt information again;
a correspondence storage determining sub-module configured to determine whether the correspondence between the display interface and the user identity information Inf_{UID} is to be stored in the preset information list.

27-28. (canceled)

29. An electronic device, wherein the electronic device comprises: a housing, a processor, a memory, a circuit board and a power supply circuit, wherein the circuit board is disposed in a space surrounded by the housing, and the processor and the memory are disposed on the circuit board; the power supply circuit is configured to supply power for circuits and elements of the electronic device; the memory is configured to store executable program codes;
the processor is configured to execute a program corresponding to the executable program codes by reading the executable program codes stored in the memory, so as to cause the processor to:
monitor whether a display interface of an application in a foreground running state contains a user identity authentication area;
if the display interface of the application in the foreground running state contains a user identity authentication area, determine whether user identity authentication is to be performed in a quick authentication manner;
obtain a quick authentication password input by a user, if the user identity authentication is to be performed in the quick authentication manner;
determine whether the quick authentication password input by the user is a quick authentication password of any piece of user identity information corresponding to the display interface stored in a preset information list, wherein the preset information list is used to store user identity information corresponding to an interface containing a user identity authentication area and quick authentication passwords corresponding to respective pieces of user identity information;
if the quick authentication password input by the user is the quick authentication password of any piece of user identity information corresponding to the display interface, obtain, from user identity information corresponding to the display interface stored in the preset information list, user identity information corresponding to the quick authentication password input by the user; and
when a system privilege is obtained, send the obtained user identity information to the application in the foreground running state, so as to cause the application in the foreground running state to perform the user identity authentication via a server according to the obtained user identity information.

30. (canceled)

31. A non-transitory storage medium storing executable program codes, wherein the executable program codes are used to perform the method for processing information according to claim 1.
